(19) United States
(12) Patent Application Publication
(10) Pub. No.: US 2026/0160647 A1
(43) Pub. Date: Jun. 11, 2026

(54) Tire Accelerated Aging Oven

(71) Applicant: EKTRON TEK CO., LTD., Changhua County (TW)

(72) Inventor: Yau Dong Chang, Changhua County (TW)

(21) Appl. No.: 18/977,870

(22) Filed: Dec. 11, 2024

(51) Int. Cl. G01M 17/02

(52) U.S. Cl. CPC G01M 17/021

(57) ABSTRACT

A tire accelerated aging oven, including: an oven having therein a test space and at least one environmental regulator; and a test table disposed in the test space to support at least one tire, provided with at least one pressure tube with one end connected to a valve of the tire, having a bottom end connected to a driving mechanism for undergoing rotational movement, and having a top end connected to one end of a driven mechanism. The other end of the driven mechanism penetrates a rotation mechanism to protrude from the oven. The other end of the pressure tube extends upward along the driven mechanism to protrude from the oven to connect to a pressure sensor to protect the pressure sensor against damage and malfunction otherwise caused by environmental condition changes and prevent tire bursts.

### FIELD

The present disclosure relates to tire test equipment, and more particularly to a tire accelerated aging oven.

### BACKGROUND

Conventional tire aging testers are mainly designed to test strips of tire materials, such as rubber and silicone. Furthermore, conventional tire aging testers are dedicated to static tire tests. Static tire tests are effective in assessing the extent of the aging of the tire material strips under various environmental conditions. However, conventional tire aging testers neither conduct dynamic tire tests nor collect test data about an entire tire in an environmental space. As a result, the test data obtained by conventional tire aging testers is neither adequate nor directly applicable. In short, conventional tire aging testers are not effective in performing aging testing and thus still have room for improvement.

A commercially-available tire aging tester for performing tire aging testing is designed to address the aforesaid test data inadequacy issue with the aforesaid conventional tire aging testers. The tire aging tester is not only capable of adjusting temperature, humidity, and other environmental parameters therein but also effective in performing dynamic testing on a tire in a space under specific environmental conditions through internal mechanism of the tire aging tester. However, the tire testing performed with the tire aging tester usually necessitates mounting a pressure sensor on a tire valve to detect changes of tire pressure in the course of the tire testing. The pressure sensor is made of plastic materials and electronic materials and in consequence is not resistant to high temperature. Furthermore, ozone is usually included in environmental conditions to form an ozone environment for not only speeding up tire aging but also quickly obtaining aging test data. However, the ozone environment is likely to cause the pressure sensor to get damaged or malfunction, preventing every monitoring technician from effectively detecting changes of tire pressure in the course of the tire testing, greatly reducing the precision of test data, and even leading to a burst of a tire having aged to a point of incapable of withstanding the tire pressure.

### SUMMARY

In view of the aforesaid drawbacks of the prior art, it is an objective of the disclosure to provide a tire accelerated aging oven in a way conducive to the enhancement of test data precision and test safety.

To achieve the above and other objectives, the disclosure provides a tire accelerated aging oven, comprising: an oven having therein a test space provided with a first environmental regulator and a second environmental regulator, both adapted to further adjust environmental conditions in the test space; and a test table disposed in the test space to support at least one tire, having a bottom end connected to a driving mechanism for undergoing rotational movement, and having a top end connected to one end of a driven mechanism, the driven mechanism having the other end penetrating a rotation mechanism to protrude from the oven to allow the test table to use the driving mechanism and the driven mechanism as a fulcrum in undergoing rotational movement within the test space, wherein the other end of the pressure tube extends upward along the driven mechanism to protrude from the oven to connect to a pressure sensor to allow the pressure tube to become free of entanglement through the rotation mechanism while rotating together with the test table, wherein the pressure sensor is disposed outside the oven and thus protected against damage and malfunction otherwise caused by environmental conditions changes, further enhancing precision of tire aging test data and test safety.

Preferably, the first environmental regulator is a temperature control unit for adjusting a temperature condition of the test space, whereas the second environmental regulator provides and adjusts any one of ozone concentration and air humidity, in the test space.

Preferably, the driving mechanism is a driving shaft that penetrates the center of the bottom of the oven and connects to an external driving power, whereas a hermetic seal element, for example an oil seal and an O-ring, is disposed between the driving mechanism and the oven to ensure a degree of hermetic seal of the test space.

Preferably, the test table has a rack, and the center of the bottom end of the rack is connected to the driving mechanism, the driven mechanism comprising a link member, a driven shaft and a driven rotation member, the link member being fixedly disposed on one side of a top end of the rack, the driven shaft being L-shaped and having a horizontal segment and a vertical segment, the horizontal segment being connected to the link member, the vertical segment penetrating the rotation mechanism to protrude from the oven and having at least one channel lengthwise, the channel being penetrable by the pressure tube to allow the pressure tube to be pulled outward, the driven rotation member being horizontally linked to a top end of the driven shaft to support the pressure sensor, the pressure tube being connected to the pressure sensor, wherein a mask is disposed at a top end of the oven to mask the driven rotation member and the pressure sensor and having a top end provided with an electrical rotation connector electrically connected to the pressure sensor, with the electrical rotation connector supplying electric power to the pressure sensor.

Preferably, the test table can support two said tires concurrently and have two said pressure tubes, the vertical segment of the driven shaft has two said channels penetrable by the two pressure tubes to allow the two pressure tubes to be pulled outward, and the driven rotation member has two said pressure sensors connected to the two pressure tubes respectively to perform sensing.

Preferably, the pressure sensor is further provided with a pressure relief valve for releasing the tire pressure timely to prevent test environment changes which might otherwise increase the tire pressure excessively and thus lead to a resultant tire burst.

Preferably, the first and second environmental regulators and the pressure sensor exchange signals with, control and operate a 3C device through wireless transmission.

Unlike the prior art, the present invention has advantages as described below. The pressure sensor is disposed outside the oven to protect the pressure sensor against damage and malfunction otherwise caused by environmental condition changes. The driven mechanism causes the pressure tube to rotate synchronously with the test table to preclude the entanglement of the pressure tube connected between the tire and the pressure sensor. Last but not least, not only is a burst of the tire effectively prevented, but precision of tire aging test data and test safety is also enhanced.

### BRIEF DESCRIPTION OF THE DRAWINGS

FIG. 1 is a schematic view of a tire accelerated aging oven according to the disclosure.

FIG. 2 is a partial enlarged view of FIG. 1.

FIG. 3 is a schematic view of rotational movement according to the disclosure.

FIG. 4 is a schematic view of monitoring tire test data with a 3C device according to the disclosure.

### DETAILED DESCRIPTION

Objectives, features, and advantages of the disclosure are herein illustrated with specific embodiments, depicted with drawings, and described below.

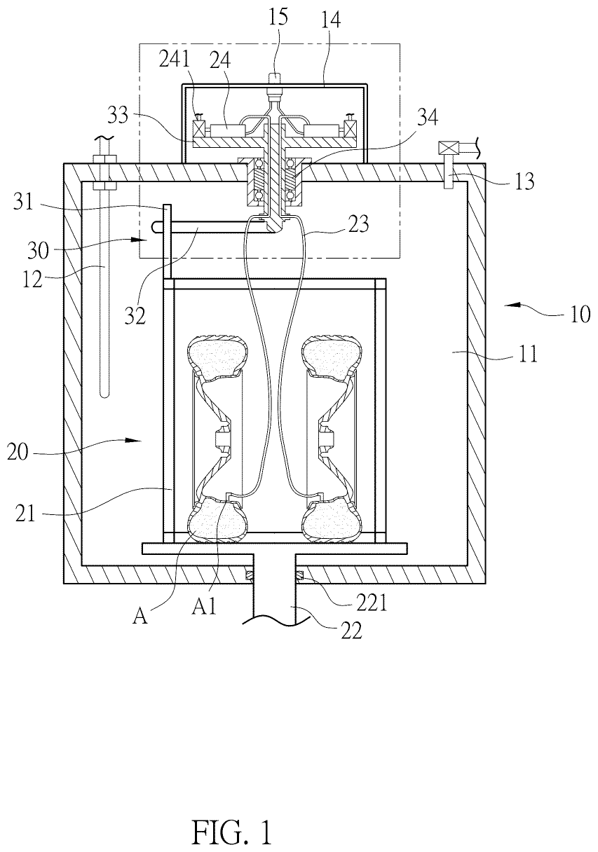

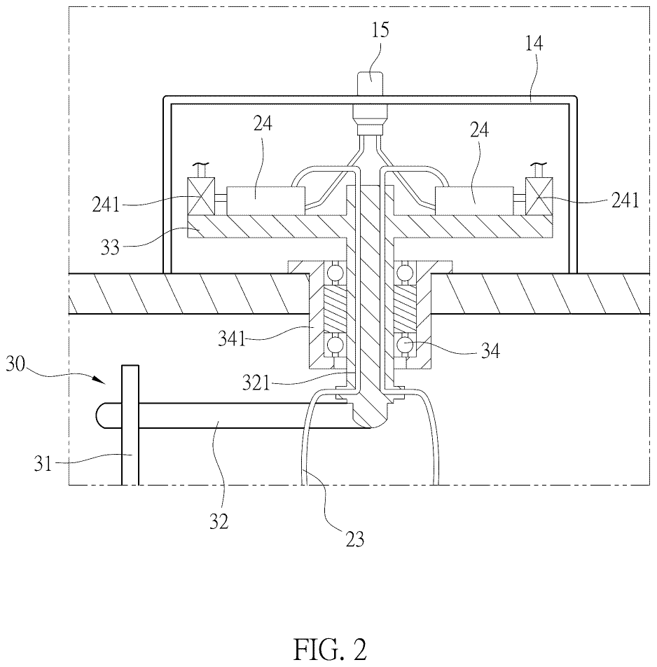

First, referring to FIGS. 1 and 2, a tire accelerated aging oven comprises an oven 10 and a test table 20. The oven 10 is an explosion-proof chamber, has a door (not shown) with a hermetically sealed opening, and has therein a test space 11. The test space 11 at least has a first environmental regulator 12 and a second environmental regulator 13. The first environmental regulator 12 is a temperature control unit for adjusting a temperature condition of the test space 11. The second environmental regulator 13 provides and adjusts any one of ozone concentration and air humidity, in the test space 11. The first and second environmental regulators 12 and 13 exchange signals with, control and operate a 3C device through wireless transmission to further adjust environmental conditions in the test space 11. The test table 20 is disposed in the test space 11 and has a rack 21 for holding at least one tire A. The center of the bottom end of the rack 21 is connected to a driving mechanism 22 for undergoing rotational movement. The top end of the rack 21 is connected to a driven mechanism 30. The driven mechanism 30 comprises a link member 31, a driven shaft 32 and a driven rotation member 33. The link member 31 is fixedly disposed on one side of the top end of the rack 21. The driven shaft 32 is L-shaped, having a horizontal segment and a vertical segment. The horizontal segment is connected to the link member 31. The vertical segment penetrates a rotation mechanism 34 to protrude from the oven 10. The rotation mechanism 34 is fixedly disposed at the top end of the oven 10 to allow the test table 20 to be rotatably received in the test space 11, using the driving mechanism 22 and the driven mechanism 30 as a fulcrum. The vertical segment has at least one channel 321 lengthwise. Outside the oven 10, the driven rotation member 33 is horizontally linked to the top end of the driven shaft 32. The test table 20 is provided with at least one pressure tube 23 with one end connected to a valve A1 of the tire A. The other end of the pressure tube 23 extends upward to penetrate the channel 321 of the driven shaft 32 before protruding from the oven 10 to connect to a pressure sensor 24. The pressure sensor 24 is disposed on the driven rotation member 33. A mask 14 is disposed at the top end of the oven 10 to mask the driven rotation member 33 and the pressure sensor 24. The top end of the mask 14 is provided with an electrical rotation connector 15 electrically connected to the pressure sensor 24. Electric power is supplied to the pressure sensor 24 via the electrical rotation connector 15.

The driving mechanism 22 is a driving shaft that penetrates the center of the bottom of the oven 10 and connects to an external driving power (not shown). A hermetic seal element 221, for example an oil seal and an O-ring, is disposed between the driving mechanism 22 and the oven 10 to ensure a degree of hermetic seal of the test space 11.

The test table 20 can support two said tires A concurrently and have two said pressure tubes 23; thus, the vertical segment of the driven shaft 32 has two said channels 321 penetrable by the two pressure tubes 23 to allow the two pressure tubes 23 to be pulled outward, whereas the driven rotation member 33 has two said pressure sensors 24 connected to the two pressure tubes 23 respectively to perform sensing. The two pressure sensors 24 wirelessly exchange signals with a 3C device B to perform control and operation so as to achieve remote operation and surveillance. Furthermore, the two pressure sensors 24 are each provided with a pressure relief valve 241 for releasing the tire pressure timely to prevent test environment changes which might otherwise increase the tire pressure excessively and thus lead to a resultant tire burst.

The rotation mechanism 34 comprises a plurality of bearings. The bearings are not only enclosed and restrained by a casing 341 but also disposed at the center of the top end of the oven 10 through the casing 341.

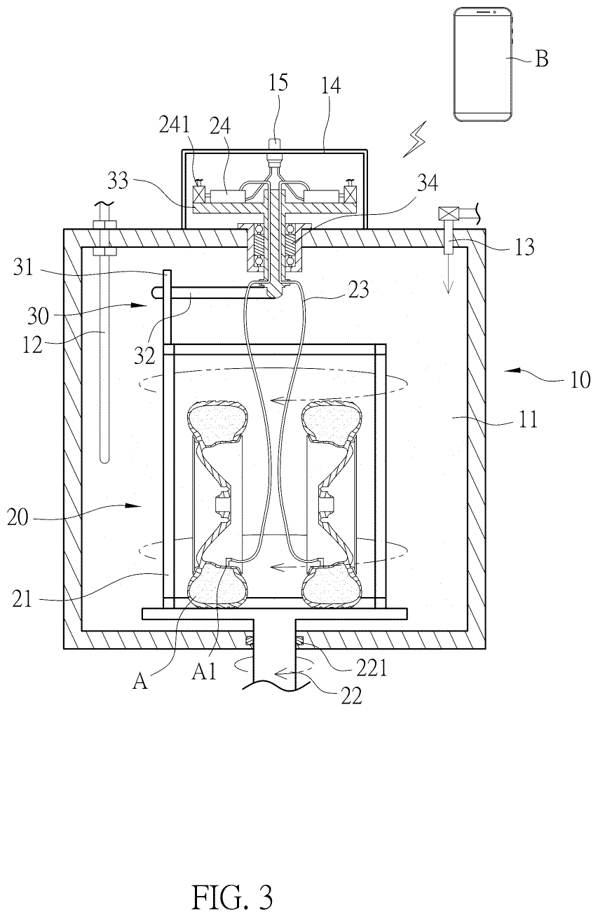

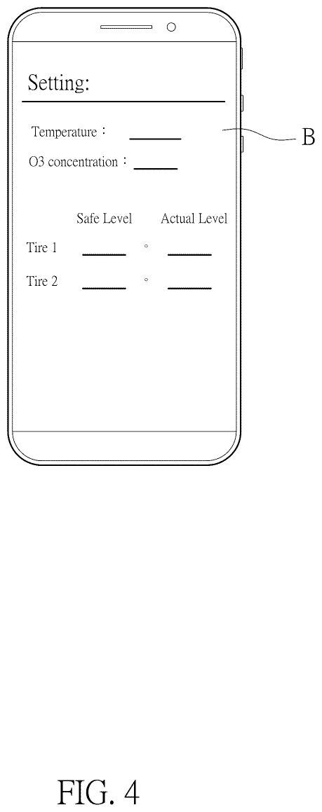

FIGS. 2, 3 and 4 show how to operate the tire accelerated aging oven according to the disclosure. The tire A to undergo an aging test is mounted on a wheel rim, then inflated under a predetermined tire pressure, and finally placed on the test table 20. Then, one end of the pressure tube 23 is connected to the valve A1 of the tire A, and the other end of the pressure tube 23 is connected to the pressure sensor 24, attaining the static setting of the tire A. After that, the driving mechanism 22 is started to drive the test table 20 undergoing rotational movement in the test space 11. The pressure tube 23 penetrates the channel 321 of the driven shaft 32 before being pulled out of the oven 10. The rotation mechanism 34 enables the driven mechanism 30 to idle relative to the oven 10. The pressure sensor 24 connected to the other end of the pressure tube 23 is disposed above the driven rotation member 33. The driven rotation member 33 rotates together with the driven shaft 32. Thus, the pressure tube 23 rotates synchronously with the test table 20 to avoid entanglement, not only allowing the pressure sensor 24 to be positioned outside the oven 10, but also allowing the pressure sensor 24 to collect test data prior to environmental adjustment.

Then, to test the tire A after environmental parameters have been configured, the oven 10 uses a 3C device B or machine device to operate and controllably cause the first and second environmental regulators 12 and 13 to set the temperature and humidity inside the test space 11 or introduce thereinto ozone gas to form an ozone space as needed to assess the extent of the aging of the tire A in various environmental conditions under a predetermined tire pressure and assess the changes of the tire pressure of the tire A in the course of an environmental change through the pressure tube 23 and the pressure sensor 24, facilitating the recording and comparison of test data of the tire A. Environmental factors cause the wall of the tire A to age and crack gradually, and in consequence the tire A bursts as soon as it fails to withstand the tire pressure. To prevent a tire burst and ensure test safety during the test process, the pressure relief valve 241 releases the tire pressure as soon as the pressure sensor 24 detects that the tire A reaches a burst critical point.

The aforesaid specific embodiments of the disclosure have advantages as described below. The pressure sensor 24 is disposed outside the oven 10 to protect the pressure sensor 24 against damage and malfunction otherwise caused by environmental condition changes. The driven mechanism 30 causes the pressure tube 23 to rotate synchronously with the test table 20 to preclude the entanglement of the pressure tube 23 connected between the tire A and the pressure sensor 24. Last but not least, not only is a burst of the tire A effectively prevented, but precision of tire aging test data and test safety is also enhanced.

Therefore, the present invention not only embodies radical innovation and improvements on prior art but also exhibits high industrial applicability, inventiveness, and novelty.

The disclosure is disclosed above by a preferred embodiment, but the preferred embodiment is not restrictive of the scope of implementation of the disclosure. All equivalent changes and modifications made to the preferred embodiment according to the claims of the disclosure shall be deemed falling within the scope of the claims of the disclosure.

What is claimed is:

1. A tire accelerated aging oven, comprising:
an oven having therein a test space provided with a first environmental regulator and a second environmental regulator, both adapted to further adjust environmental conditions in the test space; and
a test table disposed in the test space to support at least one tire, provided with at least one pressure tube with an end connected to a valve of the tire, having a bottom end connected to a driving mechanism for undergoing rotational movement, and having a top end connected to an end of a driven mechanism, the driven mechanism having another end penetrating a rotation mechanism to protrude from the oven to allow the test table to use the driving mechanism and the driven mechanism as a fulcrum in undergoing rotational movement within the test space, wherein another end of the pressure tube extends upward along the driven mechanism to protrude from the oven to connect to a pressure sensor to allow the pressure tube to become free of entanglement through the rotation mechanism while rotating together with the test table, wherein the pressure sensor is disposed outside the oven and thus protected against damage and malfunction otherwise caused by environmental conditions changes, further enhancing precision of tire aging test data and test safety.

2. The tire accelerated aging oven according to claim 1, wherein the first environmental regulator is a temperature control unit for adjusting a temperature condition of the test space, whereas the second environmental regulator provides and adjusts any one of ozone concentration and air humidity, in the test space.

3. The tire accelerated aging oven according to claim 1, wherein the driving mechanism is a driving shaft that penetrates a center of a bottom of the oven and connects to an external driving power, whereas a hermetic seal element, for example an oil seal and an O-ring, is disposed between the driving mechanism and the oven to ensure a degree of hermetic seal of the test space.

4. The tire accelerated aging oven according to claim 1, wherein the test table has a rack, and a center of a bottom end of the rack is connected to the driving mechanism, the driven mechanism comprising a link member, a driven shaft and a driven rotation member, the link member being fixedly disposed on a side of a top end of the rack, the driven shaft being L-shaped and having a horizontal segment and a vertical segment, the horizontal segment being connected to the link member, the vertical segment penetrating the rotation mechanism to protrude from the oven and having at least one channel lengthwise, the channel being penetrable by the pressure tube to allow the pressure tube to be pulled outward, the driven rotation member being horizontally linked to a top end of the driven shaft to support the pressure sensor, the pressure tube being connected to the pressure sensor, wherein a mask is disposed at a top end of the oven to mask the driven rotation member and the pressure sensor and having a top end provided with an electrical rotation connector electrically connected to the pressure sensor, with the electrical rotation connector supplying electric power to the pressure sensor.

5. The tire accelerated aging oven according to claim 4, wherein the test table can support two said tires concurrently and have two said pressure tubes, the vertical segment of the driven shaft has two said channels penetrable by the two pressure tubes to allow the two pressure tubes to be pulled outward, and the driven rotation member has two said pressure sensors connected to the two pressure tubes respectively to perform sensing.

6. The tire accelerated aging oven according to claim 1, wherein the pressure sensor is further provided with a pressure relief valve for releasing the tire pressure timely to prevent test environment changes which might otherwise increase the tire pressure excessively and thus lead to a resultant tire burst.

7. The tire accelerated aging oven according to claim 1, wherein the first and second environmental regulators and the pressure sensor exchange signals with, control and operate a 3C device through wireless transmission.
